(19) United States
(12) Patent Application Publication
(10) Pub. No.: US 2021/0135345 A1
(43) Pub. Date: May 6, 2021

(54) UNMANNED AERIAL VEHICLES AND ANTENNAE THEREOF

(71) Applicant: SZ DJI TECHNOLOGY CO., LTD., Shenzhen (CN)

(72) Inventor: Jianping WEI, Shenzhen (CN)

(73) Assignee: SZ DJI TECHNOLOGY CO., LTD., Shenzhen (CN)

(21) Appl. No.: 17/107,853

(22) Filed: Nov. 30, 2020

Related U.S. Application Data
(63) Continuation of application No. PCT/CN2018/096771, filed on Jul. 24, 2018.

(51) Int. Cl. H01Q 1/28; H01Q 9/16; H01Q 9/30; H04N 5/225; B64C 39/02; B64D 47/08

(52) U.S. Cl. CPC H01Q 1/28; H01Q 9/16; H01Q 9/30; H04N 5/2253; B64C 2201/14; B64D 47/08; B64C 2201/027; B64C 2201/127; B64C 39/024

(57) ABSTRACT

An unmanned aerial vehicle (UAV) antenna with optimal omni-directionality may include a first antenna module, a second antenna module, and a third antenna module. The first antenna module and the second antenna module are arranged opposite to each other, and the third antenna module is arranged on a side of the second antenna module which is away from the first antenna module. The first antenna module includes a first strip line feed and a first oscillator unit electrically connected to the first strip line feed; the second antenna module includes a second strip line feed and a second oscillator unit electrically connected to the second strip line feed; the third antenna module includes a third strip line feed and a third oscillator unit electrically connected to the third strip line feed; the third strip line feed is electrically connected to the second strip line feed.

### RELATED DISCLOSURES

This application is a continuation application of PCT application No. PCT/CN2018/096771, filed on Jul. 24, 2018, and the content of which are incorporated herein by reference in its entirety.

### TECHNICAL FIELD

The present disclosure relates to the technical field of unmanned aerial vehicle (UAV) antennas, and in particular, to a UAV and an antenna thereof.

### BACKGROUND

In designs for antennas of UAVs or other image transmission devices, the most common scheme of a multiband antenna is a monopole antenna, an inverted-F antenna, or the like. However, the omni-directionality of such antennas is unable to cover multiple bands. Moreover, in practical use, there are increasingly higher requirements for the omni-directionality of antennas. In addition, with an increase in communication links, dual-band antennas can no longer meet the current communication demand. Besides, an antenna of a UAV is usually designed with a large size to ensure its signal transmission quality. However, in the field of UAVs, an excessively large antenna size may affect the design of the UAV, and is adverse to the miniaturization of the UAV.

### SUMMARY

An object of the present disclosure is to provide a UAV.

An antenna of a UAV, including a first antenna module, a second antenna module and a third antenna module, the first antenna module and the second antenna module being arranged opposite to each other, and the third antenna module being arranged on a side of the second antenna module which is away from the first antenna module; the first antenna module includes a first strip line feed and a first oscillator unit electrically connected to the first strip line feed, the second antenna module includes a second strip line feed and a second oscillator unit electrically connected to the second strip line feed, the third antenna module includes a third strip line feed and a third oscillator unit electrically connected to the third strip line feed, and the third strip line feed is electrically connected to the second strip line feed.

The UAV and the antenna thereof as described above are provided with the first antenna module, the second antenna module, and the third antenna module. The first antenna module and the second antenna module are arranged opposite to each other to form a dipole scheme. The dipole scheme corresponds to a high-frequency band, such that miniaturization is realized. The third antenna module corresponds to a monopole scheme, and the monopole scheme corresponds to a low-frequency band. Therefore, the antenna of the UAV realizes coverage over two bands, that is, 840 MHz to 845 MHz and 1430 MHz to 1444 MHz, achieving good omni-directionality. Moreover, the foregoing antenna has a simple structure and a small size, realizing miniaturization.

### BRIEF DESCRIPTION OF THE DRAWINGS

FIG. 1 is a perspective diagram of a UAV according to some exemplary embodiments of the present disclosure;

FIG. 2 is a schematic diagram of electric modules of the UAV shown in FIG. 1;

FIG. 3 is a structural diagram of a UAV according to some exemplary embodiments of the present disclosure;

FIG. 4 is a diagram of standing wave simulation of the antenna shown in FIG. 3;

FIG. 5 is a diagram of signal simulation at 1.4 GHz of the antenna shown in FIG. 3; and

FIG. 6 is a diagram of signal simulation at 840 MHz of the antenna shown in FIG. 3.

Description of reference numerals: 10. UAV; 11. frame; 12. arm; 13. landing gear; 14. power device; 15. flight control system; 16. image photographing device; 17. central body; 20. antenna; 21. first antenna module; 211. strip line feed; 212. first oscillator unit; 213. first branch; 2131. body; 2132. recurved portion; 2133. first recurved arm; 2134. second recurved arm; 214. first feed guide; 22. second antenna module; 221. second strip line feed; 222. second oscillator unit; 223. second branch; 224. second feed guide; 23. third antenna module; 231. third strip line feed; 232. third oscillator unit; 233. first bent portion; 234. second bent portion; 2340. connecting arm; 2341. first bent arm; 2342. second bent arm; 2343. third bent arm; 2344. fourth bent arm; 2345. fifth bent arm; 24. feed module; 241. feed portion; 242. ground portion; 25. carrying plate.

### DETAILED DESCRIPTION

Although the present disclosure can be easily expressed as embodiments in different forms, only some specific exemplary embodiments are shown in the accompanying drawings and described in detail in the description. Besides, it will be appreciated that the description should be regarded as an exemplary description of the principle of the present disclosure, but is not intended to limit the present disclosure to the description herein.

Therefore, one feature stated in the description is used for illustrating one of the features of one embodiment of the present disclosure, but does not imply that each embodiment needs to have the stated feature. In addition, it should be noted that many features are described in the description. Although some features may be combined together to show a possible system design, such features may also be used for other combinations not expressly stated. Therefore, unless otherwise specified, all stated combinations are not intended for limitations.

In the exemplary embodiments shown in the drawings, indications of directions (such as upper, lower, left, right, front and rear), which are relative but not absolute, are used for explaining structures and movements of various components of the present disclosure. Such descriptions are appropriate when the components are located at positions shown in the drawings. If the descriptions about the positions of the components change, the indications of the directions may also change accordingly.

The following further describes some exemplary embodiments of the present disclosure in detail with reference to the accompanying drawings of the description. If no conflict occurs, the following exemplary embodiments and features in these exemplary embodiments may be combined.

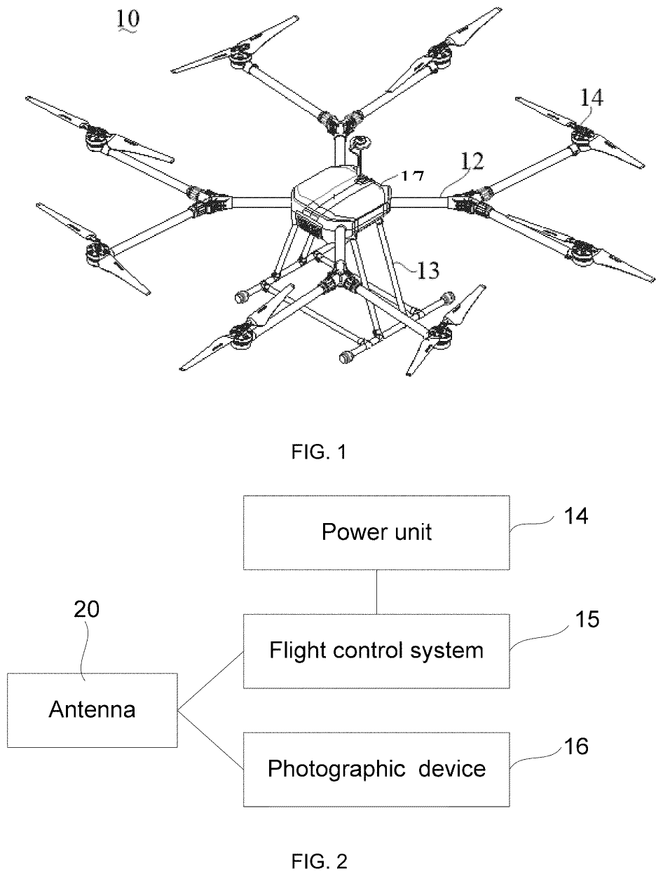

Referring to FIG. 1 and FIG. 2, a UAV 10 is provided. The UAV includes a frame 11, a plurality of power devices 14, a flight control system 15, an image photographing device 16, and an antenna 20.

Referring to FIG. 1, the frame 11 includes a central body 17, arms 12, and a landing gear 13. The arms 12 are connected to the central body 17. The landing gear is connected to the central body 17 and the arms 12. In other embodiments, the landing gear 13 may be directly disposed on the central body 17 or the arms 12.

The plurality of power devices 14 may be disposed on the arms 12. The power devices 14 may be propellers to provide power for the entire UAV.

The flight control system 15 is disposed on the central body 17 of the frame 11. The flight control system 15 is communicatively connected to the plurality of power devices 14, so as to control the power devices 14 to provide flight power. It may be appreciated that, the flight control system 15 may control the rotation speed regulation of the power devices 14.

Referring to FIG. 2, the image photographing device 16 is mounted on the central body 17 of the frame 11, and acquires image data during a flight of the UAV. The image photographing device 16 may be a camera.

The antenna 20 is mounted on the landing gear 13. In other embodiments, the antenna 20 may alternatively be mounted in other structures of the frame 11. The antenna 20 is used for providing signal transmission for the UAV. The antenna 20 is communicatively connected to the flight control system 15 and the image photographing device 16. The flight control system 15 receives a control signal from a ground control terminal through the antenna 20. The image photographing device 16 transmits image data to the ground control terminal through the antenna 20.

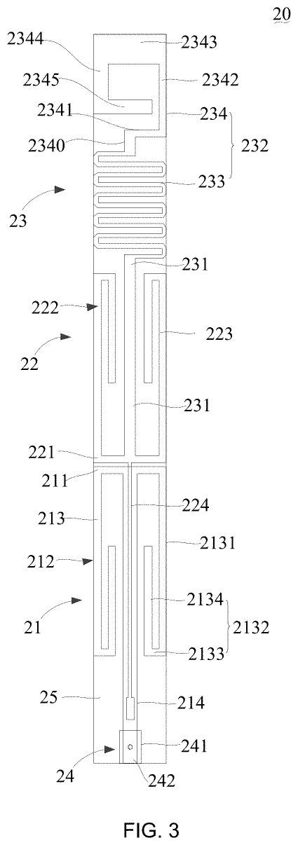

Referring to FIG. 3, specifically, the antenna 20 of the UAV in this exemplary embodiment includes a first antenna module 21, a second antenna module 22, and a third antenna module 23. The first antenna module 21 and the second antenna module 22 are arranged opposite to each other. The third antenna module 23 is arranged on a side of the second antenna module 22 which is away from the first antenna module 21.

The first antenna module 21 includes a first strip line feed 211 and a first oscillator unit 212 electrically connected to the first strip line feed 211. The second antenna module 22 includes a second strip line feed 221 and a second oscillator unit 222 electrically connected to the second strip line feed 221. The third antenna module 23 includes a third strip line feed 231 and a third oscillator unit 232 electrically connected to the third strip line feed 231. The third strip line feed 231 and the second strip line feed 221 are electrically connected.

The first oscillator unit 212 and the second oscillator unit 222 are in a mirror-symmetric arrangement.

The first oscillator unit 212 and the second oscillator unit 222 each include a plurality of branches. The branches of the first oscillator unit 212 are arranged opposite to each other at two ends of the first strip line feed 211. The branches of the second oscillator unit 222 are arranged opposite to each other at two ends of the second strip line feed 221. Specifically, in this exemplary embodiment, the first oscillator unit 212 and the second oscillator unit 222 each include two branches. For ease of description, the first oscillator unit 212 includes two first branches 213. The second oscillator unit 222 includes two second branches 223. That is, the two first branches 213 are arranged at two ends of the first strip line feed 211 respectively. The two second branches 223 are arranged at two ends of the second strip line feed 221 respectively.

The branches are in a mirror-symmetric arrangement. That is, the two first branches 213 are in a mirror-symmetric arrangement. The two second branches 223 are in a mirror-symmetric arrangement. Moreover, the two first branches 213 and the two second branches 223 are also in a mirror-symmetric arrangement.

Specifically, in this description, the first branch 213 is used as an example for description. The structure of the second branch 223 is similar to that of the first branch 213, and will not be described in detail herein.

The first branch 213 includes a body 2131 and a recurved portion 2132. The body 2131 extends along an extension direction of the antenna. The body 2131 is straight-line-shaped. The recurved portion 2132 is arranged at a tail end of the body 2131. The recurved portion 2132 is bent.

The recurved portion 2132 includes a first recurved arm 2133. The first recurved arm 2133 is tilted relative to the body 2131 by a first preset angle, and is bent and extends towards an inner side of the antenna. A length of the first recurved arm 2133 is less than or equal to a distance between the body 2131 and the third strip line feed 231. The first recurved arm 2133 does not increase a lateral dimension of the first oscillator unit 212, so that a longitudinal dimension of the first oscillator unit 212 is reduced as much as possible while the minimum lateral dimension of the first oscillator unit 212 is maintained.

The first preset angle is 60 degrees to 120 degrees. For example, the third present angle may be 60°, 62°, 64°, 66°, 68°, 70°, 72°, 74°, 76°, 78°, 80°, 82°, 84°, 86°, 88°, 90° 92°, 94°, 96°, 98°, 100°, 102°, 104°, 106°, 108°, 110°, 112°, 114°, 116°, 118°, 120°, or an angle in a range between any two of the aforementioned angles. The first recurved arm 2133 is bent by the first preset angle, so as to reduce a longitudinal length of the first branch 213. Specifically, in this exemplary embodiment, the first preset angle is 90 degrees. That is, the first recurved arm 2133 and the body 2131 are arranged perpendicular to each other.

A second recurved arm 2134 is arranged at a tail end of the first recurved arm 2133.

The second recurved arm 2134 is tilted relative to the first recurved arm 2133 by a second preset angle, and is bent and extends towards the first strip line feed 211. The second preset angle is 60 degrees to 120 degrees. For example, the third present angle may be 60°, 62°, 64°, 66°, 68°, 70°, 72°, 74°, 76°, 78°, 80°, 82°, 84°, 86°, 88°, 90°, 92°, 94°, 96°, 98°, 100°, 102°, 104°, 106°, 108°, 110°, 112°, 114°, 116°, 118°, 120°, or an angle in a range between any two of the aforementioned angles. The second recurved arm 2134 is bent by the second preset angle, so as to reduce a width of the first branch 213. Specifically, in this exemplary embodiment, the second preset angle is 90 degrees. That is, the second recurved arm 2134 and the first recurved arm 2133 are arranged perpendicular to each other.

A length of the second recurved arm 2134 is less than a distance between the tail end of the first recurved arm 2133 and the first strip line feed 211. A distance between a free end of the first branch 213 and a free end of the second branch 223 is greater than a jamming distance between two branches, thereby preventing mutual interference due to an excessively short distance between a free end of the second recurved arm 2134 of the first branch 213 and a free end of the second recurved arm 2134 of the second branch 223.

In other embodiments, the first oscillator unit 212 may alternatively include four branches or six branches. The number of branches is not limited herein. Moreover, the bent portion of the branch may alternatively include three or four recurved arms, or the like.

The first strip line feed 211 and the second strip line feed 221 abut on and/or are adjacent to each other. The first antenna module 21 and the second antenna module 22 abut on and/or are adjacent to each other, to avoid occupying extra space, and reduce a longitudinal length of the antenna as much as possible.

The antenna 20 of the UAV further includes a feed module 24. The second strip line feed 221 is electrically connected to the feed module 24, and the first strip line feed 211 is grounded through the feed module 24. The feed module 24 is arranged on a side of the second antenna module 22 which is away from the first antenna module 21. The feed module 24 is a coaxial line feed. The coaxial line feed includes a feed portion 241 and a ground portion 242 that are arranged coaxially. The ground portion 242 is located on an outer side of the feed portion 241. The first strip line feed 211 is connected to the ground portion 242.

The first strip line feed 211 of the first antenna module 21 is electrically connected to the feed module 24. The second strip line feed 221 of the second antenna module 22 is grounded through the feed module 24. The first antenna module 21 is further provided with a first feed guide 214, and the first strip line feed 211 is grounded through the first feed guide 214. Specifically, one end of the first feed guide 214 is connected to the middle of the first strip line feed 211, and the other end of the first feed guide 214 is connected to the feed portion 241 of the feed module 24.

The second antenna module 22 is further provided with a second feed guide 224. The second strip line feed 221 is electrically connected to the feed module 24 through the second feed guide 224. Specifically, one end of the second feed guide 224 is connected to the middle of the second strip line feed 221.

The third strip line feed 231 of the third antenna module 23 is arranged perpendicular to the second strip line feed 221. Specifically, the third strip line feed 231 is connected to the middle of the second strip line feed 221. The third antenna module 23 is led out from the middle of the second antenna module 22.

The third oscillator unit 232 of the third antenna module 23 includes a first bent portion 233 and a second bent portion 234. The first bent portion 233 is arranged close to the second antenna module 22, and one end of the first bent portion 233 is connected to the third strip line feed 231. The third strip line feed 231 is electrically connected to the feed portion of the feed module 24 through the second strip line feed 221.

Specifically, in this exemplary embodiment, the first bent portion 233 is provided with a plurality of S-shaped bends. With the S-shaped structure, the first bent portion 233 occupies a small space. The first bent portion 233 is provided with 5 bends. The number of bends is set according to a resonance frequency.

The second bent portion 234 is provided with a plurality of bent arms. The second bent portion 234 adopts a bent structure with folding arms, to avoid severe coupling between the second bent portion 234 and the first bent portion 233 and ensure good low-frequency resonance.

Specifically, the bent arms include a first bent arm 2341, a second bent arm 2342, a third bent arm 2343, and a fourth bent arm 2344 in sequence.

The first bent portion 233 is provided with a connecting arm 2340 at another end. The connecting arm 2340 extends from the middle of the first bent portion 233. The first bent arm 2341 is connected to the connecting arm 2340; the first bent arm 2341 is tilted relative to the connecting arm 2340 by a third preset angle and extends towards the outer side of the antenna. The third preset angle is any degree between 60° and 120°. For example, the third present angle may be 60°, 62°, 64°, 66°, 68°, 70°, 72°, 74°, 76°, 78°, 80°, 82°, 84°, 86°, 88°, 90°, 92°, 94°, 96°, 98°, 100°, 102°, 104°, 106°, 108°, 110°, 112°, 114°, 116°, 118°, 120°, or an angle in a range between any two of the aforementioned angles. The first bent arm 2341 is bent by the third preset angle. Specifically, in this exemplary embodiment, the third preset angle is 90 degrees. That is, the first bent arm 2341 and the connecting arm 2340 are arranged perpendicular to each other.

The second bent arm 2342 is arranged at a tail end of the first bent arm 2341. The second bent arm 2342 is tilted relative to the first bent arm 2341 by a fourth preset angle, and is bent and extends away from the first bent portion 233. The fourth preset angle is 60 degrees to 120 degrees. The second bent arm 2342 is bent by the fourth preset angle, to reduce a longitudinal length of the first bent arm 2341. Specifically, in this exemplary embodiment, the fourth preset angle is 90 degrees. That is, the second bent arm 2342 and the first bent arm 2341 are arranged perpendicular to each other.

The third bent arm 2343 is arranged at a tail end of the second bent arm 2342. The third bent arm 2343 is tilted relative to the second bent arm 2342 by a fifth preset angle, and extends towards another side of the antenna. The fifth preset angle is 60 degrees to 120 degrees. The third bent arm 2343 is bent by the fifth preset angle, to reduce a longitudinal length of the second bent arm 2342. Specifically, in this exemplary embodiment, the fifth preset angle is 90 degrees. That is, the third bent arm 2343 and the second bent arm 2342 are arranged perpendicular to each other.

A width of the third bent arm 2343 is greater than a width of the second bent arm 2342.

The fourth bent arm 2344 is arranged at a tail end of the third bent arm 2343. The fourth bent arm 2344 is tilted relative to the third bent arm 2343 by a sixth preset angle, and extends towards the first bent portion 233. The sixth preset angle is 60 degrees to 120 degrees. The fourth bent arm 2344 is bent by the sixth preset angle, to reduce a lateral length of the third bent arm 2343. Specifically, in this exemplary embodiment, the sixth preset angle is 90 degrees. That is, the fourth bent arm 2344 and the third bent arm 2343 are arranged perpendicular to each other.

A width of the fourth bent arm 2344 is less than a width of the third bent arm 2343, and the width of the fourth bent arm 2344 is greater than the width of the second bent arm 2342.

The fifth bent arm 2345 is arranged at a tail end of the fourth bent arm 2344. The fifth bent arm 2345 is tilted relative to the fourth bent arm 2344 by a seventh preset angle and extends towards one side of the second bent portion 234. The seventh preset angle is 60 degrees to 120 degrees. The fifth bent arm 2345 is bent by the seventh preset angle, to reduce a longitudinal length of the fourth bent arm 2344. Specifically, in this exemplary embodiment, the seventh preset angle is 90 degrees. That is, the fifth bent arm 2345 and the fourth bent arm 2344 are arranged perpendicular to each other.

Specifically, in this exemplary embodiment, the first antenna module 21 and the second antenna module 22 are half-wave dipole oscillators. The branches of the first antenna module 21 and the second antenna module 22 are oscillator branches of 1.4 GHz frequency band.

The third antenna module 23 is a monopole oscillator. The third oscillator unit 232 of the third antenna module 23 is a monopole oscillator of 840 MHz frequency band.

Referring to FIG. 3, specifically, the antenna 20 in this exemplary embodiment further includes a carrying plate 25. The carrying plate 25 is used for carrying the first antenna module 21, the second antenna module 22, the third antenna module 23, and the feed module 24.

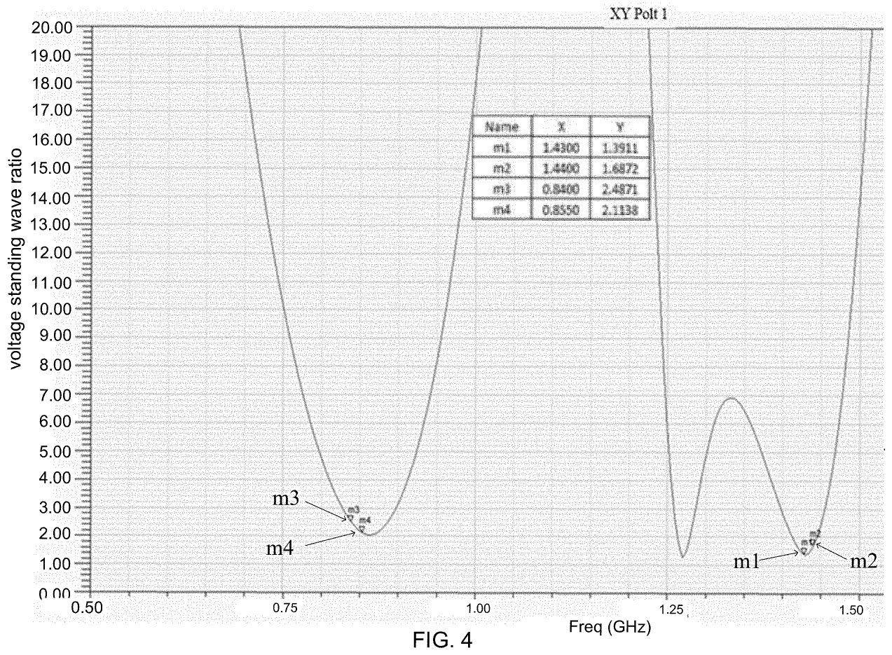

Referring to FIG. 4, FIG. 4 is a diagram of standing wave simulation of the antenna, and is specifically an s-parameter simulation diagram of the antenna. As can be seen, the standing waves in two bands, namely, 840 MHz to 845 MHz, and 1430 MHz to 1444 MHz, are both less than 3.

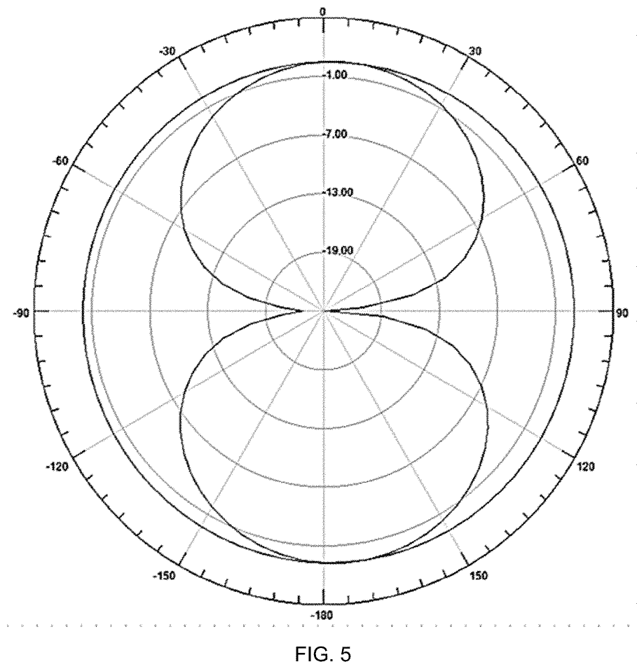

Referring to FIG. 5, FIG. 5 is a diagram of signal simulation at 1.4 GHz of the antenna of the UAV according to this exemplary embodiment. As can be seen from FIG. 5, on a plane where phi=0, the out-of-roundness is less than 2 dB. The omni-directionality is achieved, and the gain is 0.98 dBi. The antenna can desirably achieve complete coverage over a low-frequency band.

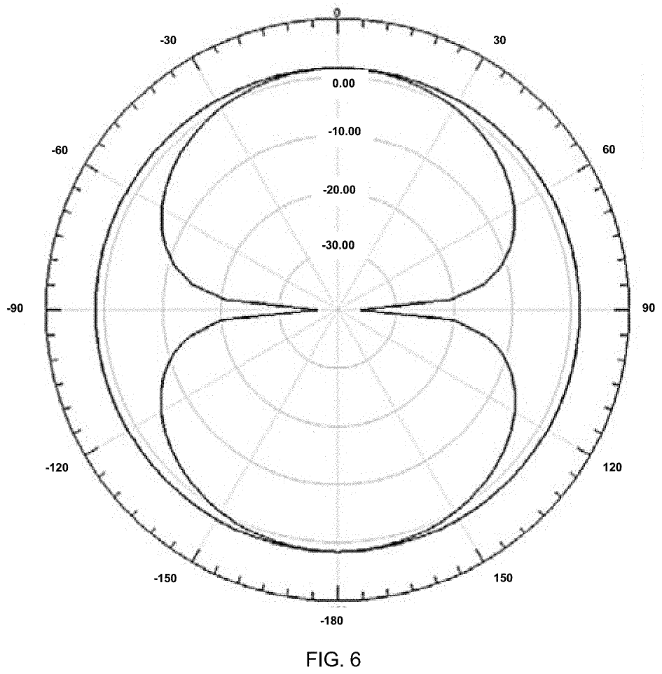

FIG. 6 is a diagram of signal simulation at 840 MHz of the antenna of the UAV according to this exemplary embodiment. As can be seen from FIG. 6, on a plane where phi=0, the out-of-roundness is less than 1 dB. The omni-directionality is excellent, and the gain is 1.54 dBi. The antenna can desirably achieve complete coverage over a high-frequency band.

Moreover, the foregoing antenna has a simple structure and a small size, realizing miniaturization. The dimensions of the antenna are 100 mm*10 mm*0.8 mm.

The UAV and the antenna thereof as described above are provided with the first antenna module 21, the second antenna module 22, and the third antenna module 23. The first antenna module 21 and the second antenna module 22 are arranged opposite to each other to form a dipole scheme. The dipole scheme corresponds to a high-frequency band, such that miniaturization is realized. The third antenna module 23 corresponds to a monopole scheme, and the monopole scheme corresponds to a low-frequency band. Therefore, the antenna of the UAV realizes coverage over two bands, that is, 840 MHz to 845 MHz and 1430 MHz to 1444 MHz, achieving good omni-directionality. Moreover, the foregoing antenna has a simple structure and a small size, realizing miniaturization.

Although the present disclosure has been described with reference to several exemplary embodiments, it should be appreciated that the terms used herein are for the purpose of description and illustration, and are not limiting terms. The present disclosure can be specifically implemented in many forms without departing from the spirit or essence of the present disclosure. Therefore, it should be appreciated that the foregoing exemplary embodiments are not limited to any aforementioned details, but should be broadly interpreted according to the spirit and scope defined by the appended claims. Therefore, all changes and modifications falling within the claims or an equivalent range thereof shall be covered by the appended claims.

What is claimed is:

1. An unmanned aerial vehicle (UAV), comprising:
a frame,
a plurality of power devices configured to provide flight power for the UAV,
a flight control system communicatively connected to the plurality of power devices and configured to rotation speed of the power devices;
an image photographing device mounted on the frame and configured to acquire image data during a flight of the UAV, and
an antenna communicatively connected to the flight control system and the image photographing device, the flight control system receiving a control signal from a ground control terminal through the antenna, and the image photographing device transmitting image data to the ground control terminal through the antenna,
wherein the antenna incudes:
a first antenna module, including a first strip line feed and a first oscillator unit electrically connected to the first strip line feed;
a second antenna module, being arranged opposite to the first antenna module, and including a second strip line feed and a second oscillator unit electrically connected to the second strip line feed; and
a third antenna module being arranged on a side of the second antenna module away from the first antenna module, and including a third strip line feed and a third oscillator unit electrically connected to the third strip line feed, wherein the third strip line feed is electrically connected to the second strip line feed.

2. The UAV according to claim 1, wherein the first oscillator unit and the second oscillator unit are in a mirror-symmetric arrangement;
the first oscillator unit and the second oscillator unit each include more than one branches.

3. The UAV according to claim 2, wherein the branches of the first oscillator unit are arranged opposite to each other at two ends of the first strip line feed, and
the branches of the second oscillator unit are arranged opposite to each other at two ends of the second strip line feed.

4. The UAV according to claim 2, wherein the branches each include a body and a recurved portion arranged at a tail end of the body, and
the body extends along an extension direction of the antenna.

5. The UAV according to claim 4, wherein the recurved portion includes a first recurved arm tilted relative to the body by a first preset angle that is between 60° and 120°, and is bent and extends towards an inner side of the antenna.

6. The UAV according to claim 5, wherein a length of the first recurved arm is less than or equal to a distance between the body and the third strip line feed.

7. The UAV according to claim 5, wherein a second recurved arm is arranged at a tail end of the first recurved arm.

8. The UAV according to claim 7, wherein the second recurved arm is tilted relative to the first recurved arm by a second preset angle that is between 60° and 120°, and is bent and extends towards the first strip line feed.

9. The UAV according to claim 1, wherein the first strip line feed and the second strip line feed are adjacent on each other, and
the third strip line feed and the second strip line feed are arranged perpendicular to each other.

10. The UAV according to claim 1, further comprising a feed module electrically connected to the second strip line feed and grounded the first strip line feed.

11. The UAV according to claim 10, wherein the first antenna module further includes a first feed guide, and the first strip line feed is grounded through the first feed guide.

12. The UAV according to claim 10, wherein the second antenna module further includes a second feed guide, and the second strip line feed is electrically connected to the feed module through the second feed guide.

13. The UAV according to claim 10, wherein the feed module includes a coaxial line feed, wherein
the coaxial line feed includes a feed portion and a ground portion being outside of and coaxial with the feed portion, and
the first strip line feed is connected to the ground portion.

14. The UAV according to claim 1, wherein the third oscillator unit of the third antenna module includes:
a first bent portion arranged close to the second antenna module, one end of the first bent portion being connected to the third strip line feed; and
a second bent portion.

15. The UAV according to claim 14, wherein the first bent portion includes a plurality of S-shaped bends, and
the second bent portion includes a plurality of bent arms.

16. The UAV according to claim 14, wherein the first bent portion includes a connecting arm at another end, the connecting arm extends from a middle of the first bent portion;
the bent arms include a first bent arm, the first bent arm is connected to the connecting arm and
the first bending arm is tilted relative to the connecting arm by a third preset angle and extends towards an outer side of the antenna.

17. The UAV according to claim 16, wherein a second bent arm is arranged at a tail end of the first bent arm, and
the second bent arm is tilted relative to the first bent arm by a fourth preset angle, and is bent and extends away from the first bent portion.

18. The UAV according to claim 17, wherein a third bent arm is arranged at a tail end of the second bent arm, and
the third bent arm is tilted relative to the second bent arm by a fifth preset angle and extends towards another side of the antenna.

19. The UAV according to claim 18, wherein a width of the third bent arm is greater than a width of the second bent arm.

20. The UAV according to claim 1, wherein the first antenna module and the second antenna module are half-wave dipole oscillators, and the third antenna module is a monopole oscillator.
